(19) United States
(12) Patent Application Publication
(10) Pub. No.: US 2024/0179753 A1
(43) Pub. Date: May 30, 2024

(54) INITIATION OF SMALL DATA TRANSMISSION

(71) Applicant: NOKIA TECHNOLOGIES OY, Espoo (FI)

(72) Inventors: Chunli WU, Beijing (CN); Samuli Heikki TURTINEN, Ii (FI); Jussi-Pekka KOSKINEN, Oulu (FI)

(73) Assignee: NOKIA TECHNOLOGIES OY, Espoo (FI)

(21) Appl. No.: 18/552,138

(22) PCT Filed: Mar. 22, 2021
(86) PCT No.: PCT/CN2021/081989

§ 371 Date: Sep. 22, 2023

(51) Int. Cl. H04W 74/0833

(52) U.S. Cl. CPC H04W 74/0833

(57) ABSTRACT

Example embodiments of the present disclosure relate to initiation of small data transmission (SDT). A first device determines whether SDT is allowed to be initiated at a first protocol layer of the first device. In accordance with a determination that the SDT is allowed to be initiated at the first protocol layer, the first device determines whether the SDT is allowed to be initiated at a second protocol layer of the first device. In accordance with a determination that the SDT is allowed to be initiated at the second protocol layer, the first device initiates, via the first protocol layer, a communication procedure for the SDT with a second device. Through this solution, it is possible to avoid unnecessary interactions between protocol layers as well as avoid false resume of the radio bearer when the SDT procedure cannot be performed.

### FIELD

Embodiments of the present disclosure generally relate to the field of telecommunication and in particular, to a device, method, apparatus and computer readable storage medium for initiation of small data transmission (SDT).

### BACKGROUND

In some communication systems, a communication device can transition between an inactive state and a connected state. In the inactive state, the communication device may not have a connection established with a network device for communications. To avoid unnecessary signaling overhead and power consumption for establishing or reestablishing a connection, the communication device in the inactive state may perform a small data transmission (SDT) procedure with other communication device, without requiring establishing a connection with the other communication device.

### SUMMARY

In general, example embodiments of the present disclosure provide a solution for initiation of SDT. Embodiments that do not fall under the scope of the claims, if any, are to be interpreted as examples useful for understanding various embodiments of the disclosure.

In a first aspect, there is provided a first device. The first device comprises at least one processor; and at least one memory including computer program code; where the at least one memory and the computer program code are configured to, with the at least one processor, cause the first device to determine whether a small data transmission is allowed to be initiated at a first protocol layer of the first device; in accordance with a determination that the small data transmission is allowed to be initiated at the first protocol layer, determine whether the small data transmission is allowed to be initiated at a second protocol layer of the first device; and in accordance with a determination that the small data transmission is allowed to be initiated at the second protocol layer, initiate, via the first protocol layer, a communication procedure for the small data transmission with a second device.

In a second aspect, there is provided a method. The method comprises determining, at a first device, whether a small data transmission is allowed to be initiated at a first protocol layer of the first device; in accordance with a determination that the small data transmission is allowed to be initiated at the first protocol layer, determining whether the small data transmission is allowed to be initiated at a second protocol layer of the first device; and in accordance with a determination that the small data transmission is allowed to be initiated at the second protocol layer, initiating, via the first protocol layer, a communication procedure for the small data transmission with a second device.

In a third aspect, there is provided a first apparatus. The first apparatus comprises means for determining whether a small data transmission is allowed to be initiated at a first protocol layer of the first apparatus; means for, in accordance with a determination that the small data transmission is allowed to be initiated at the first protocol layer, determining whether the small data transmission is allowed to be initiated at a second protocol layer of the first apparatus; and means for, in accordance with a determination that the small data transmission is allowed to be initiated at the second protocol layer, initiating, via the first protocol layer, a communication procedure for the small data transmission with a second apparatus.

In a fourth aspect, there is provided a computer readable medium. The computer readable medium comprises program instructions for causing an apparatus to perform at least the method according to the first aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates an example protocol stack of a device in which example embodiments of the present disclosure can be implemented;

FIG. 3 illustrates a signaling flow for SDT initiation among protocol layers of a device according to some example embodiments of the present disclosure;

FIG. 4 illustrates a flowchart of a method implemented at a first device according to some example embodiments of the present disclosure;

FIG. 5 illustrates a simplified block diagram of a device that is suitable for implementing example embodiments of the present disclosure; and

FIG. 6 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/of” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an JAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoTP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMID), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an JAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, a resource in both frequency domain and time domain will be used as an example of a transmission resource for describing some example embodiments of the present disclosure. It is noted that example embodiments of the present disclosure are equally applicable to other resources in other domains.

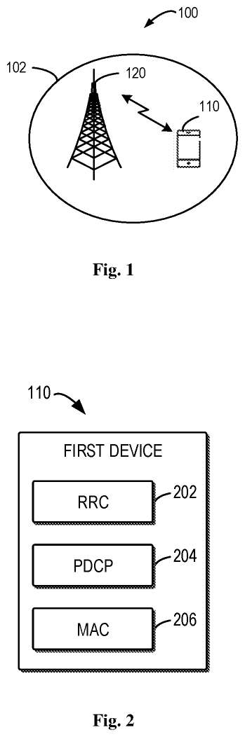

FIG. 1 shows an example communication environment 100 in which example embodiments of the present disclosure can be implemented. In the communication environment 100, a plurality of communication devices, including a first device 110 and a second device 120 can communicate with each other.

In the example of FIG. 1, the first device 110 is illustrated as a terminal device while the second device 120 is illustrated as a network device serving the terminal device. The serving area of the second device 120 may be called a cell 102.

It is to be understood that the number of devices and their connections shown in FIG. 1 are only for the purpose of illustration without suggesting any limitation. The environment 100 may include any suitable number of devices adapted for implementing embodiments of the present disclosure. Although not shown, it would be appreciated that one or more additional devices may be located in the cell 102, and one or more additional cells may be deployed in the environment 100. It is noted that although illustrated as a network device, the second device 120 may be other device than a network device. Although illustrated as a terminal device, the first device 110 may be other device than a terminal device.

In some example embodiments, if the first device 110 is a terminal device and the second device 120 is a network device, a link from the second device 120 to the first device 110 is referred to as a downlink (DL), while a link from the first device 110 to the second device 120 is referred to as an uplink (UL). In DL, the second device 120 is a transmitting (TX) device (or a transmitter) and the first device 110 is a receiving (RX) device (or a receiver). In UL, the first device 110 is a TX device (or a transmitter) and the second device 120 is a RX device (or a receiver).

Communications in the communication environment 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

The first device 110 and the second device 120 may include a protocol stack with multiple protocol layers. FIG. 2 illustrates an example protocol stack of the first device 110. As illustrated, the protocol stack of the first device 110 may include a radio resource control (RRC) layer 202, a packet data convergence protocol (PDCP) layer 204, and a medium access control (MAC) layer 206. Each of the protocol layers may perform corresponding services and functions to facilitate the communication of the first device 110 with other devices. In addition to the RRC layer, PDCP layer, and MAC layer, the protocol stack of the first device 110 may include further protocol layers although not illustrated. Other protocol layers may include a non-access stratum (NAS) on top of the RRC layer, a radio link control (RLC) layer between the RRC layer and the MAC layer, and a physical (PHY) layer.

Although not illustrated, the second device 120 may include a similar protocol stack to the first device 110. Communications between the devices, such as between the first device 110 and the second device 120, generally occur within the same protocol layer between the two devices. For example, communications from the RRC layer 202 at the first device 110 travel through the PDCP layer 204, the MAC layer 206, and are sent over the PHY layer to the second device 120. When received at the second device 120, the communications travel through the protocol layers of the second device 120 in the reverse order.

During operation, a device (e.g., a terminal device) can transition between an inactive state and a connected state. The inactive state may sometimes be referred to as an inactive mode, an RRC_INACTIVE state/mode, and such terms are used interchangeably herein. The connected state may sometimes be referred to as a connected mode, an active state/mode, or an RRC_CONNECTED state/mode, and such terms are used interchangeably herein.

Generally, there is a certain amount of signaling overhead and power consumption to transition the terminal device from an inactive state to a connected state by establishing or reestablishing a connection between the terminal device and the network device. If connection setup and subsequently release happens for at least one data transmission of the terminal device in the inactive state no matter how small and infrequent the data packets are, it may result in unnecessary power consumption and signalling overhead. Currently, the terminal device in the inactive state may be able to perform a small data transmission (SDT). As used herein, the term “SDT” refers to a type of transmission where a small amount of data is transmitted, although other terms may also be used.

There are various applications that involve exchange of relatively small amounts of data. For example, in some applications of mobile devices, SDT may include traffic from Instant Messaging (IM) services, heart-beat or keep-alive traffic from IM or email clients and other services, push notifications from various applications, traffic from wearables (including, for example, periodic positioning information), and/or the like. In some applications of non-mobile devices, SDT may include sensor data (e.g., temperature, pressure readings transmitted periodically or in an event-triggered manner in an IoT network), metering and alerting information sent from smart meters, and/or the like.

Signalling overhead and delay for a device in the inactive state for small data packets is a general problem, not only for network performance and efficiency but also for the battery performance. In general, any device that has intermittent small data packets in the inactive state will benefit from enabling SDT. It is desired that the device should apply some criteria to select SDT or non-SDT. Those criteria may be related to the data availability, resource availability, channel qualities, SDT mode-specific checking, and so on. However, currently there is no solution specifically defining how the selection of SDT and non-SDT is performed in different protocol layers of the device.

According to some example embodiments of the present disclosure, there is provided a solution for initiation of a SDT procedure. In this solution, allowance of SDT initiation is checked at different protocol layers. If SDT is found allowed for initiation, a communication procedure for the SDT is initiated. Through this solution, before a protocol layer makes the decision to initiate SDT, allowance of SDT is further checked in the other layers.

By splitting SDT initiation criteria between different protocol layers, each of the protocol layers may focus on their relevant services and functions about SDT. It also allows various combinations of SDT initiation criteria among the protocol layers. In addition, given that some radio bearers allowed for SDT can be resumed in the condition that a SDT procedure can be initiated, it would be beneficial to define optimal split of criteria checking between the protocol layers. As such, it is possible to avoid unnecessary interactions between protocol layers as well as avoid false resume of the radio bearer when the SDT procedure cannot be performed.

Example embodiments of the present disclosure will be described in detail below with reference to the accompanying drawings.

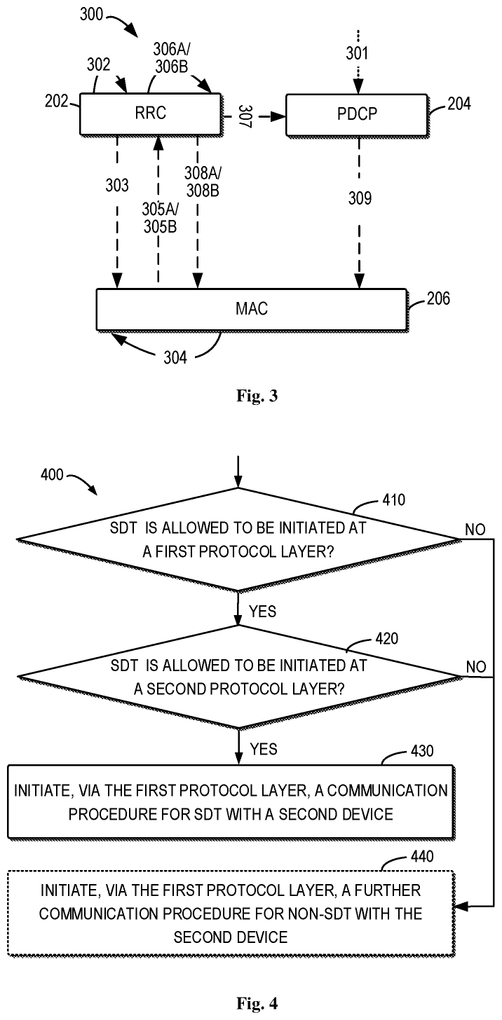

Reference is now made to FIG. 3, which shows a signaling flow 300 for SDT initiation according to some example embodiments of the present disclosure. The signaling flow 300 may involve operations and interactions between different protocol layers of the first device 110. For the purpose of discussion, reference will be made to the communication environment shown in FIG. 1 and the protocol stack shown in FIG. 2.

In operation, if there is data to be transmitted, for example, to the second device 120, the first device 110 performs corresponding processing at the respective protocol layers of the protocol stack. For example, if data arrive 301 at the PDCP layer 204 of the first device 110, other protocol layers including the RRC layer 202 and the MAC layer 206 may operate to initiate a communication procedure with the second device 120. The first device 110 may also decide whether a communication procedure for SDT or non-SDT is to be initiated in its protocol stack. In some example embodiments, the first device 110 may be in an inactive state, or may be in other operating state in which SDT is selectable for communication.

Specifically, the first device 110 determines 302 whether SDT is allowed (or available) to be initiated at a first protocol layer, e.g., the higher layer, RRC layer 202. The initiation of the SDT is triggered at the first device 110 if some predetermined criteria are satisfied. According to embodiments of the present disclosure, the criteria are split among protocol layers of the first device 110 and one or more criteria are checked at the RRC layer 202. Example criteria at the RRC layer 202 will be discussed in detail below.

If it is determined at the RRC layer 202 that the SDT is allowed (or available) to be initiated, for example, if the criteria set at the RRC layer 202 are determined to be satisfied, instead of directly resuming the radio bearer configured for SDT, the first device 110 determines 304 whether SDT is allowed to be initiated at a second protocol layer, e.g., a lower layer, MAC layer 206. According to embodiments of the present disclosure, one or more criteria are checked at the MAC layer 206 to determine whether SDT is allowed to be initiated.

In some example embodiments, if it is determined at the RRC layer 202 that the SDT is allowed to be initiated, the RRC layer 202 may send 303, to the MAC layer 206, a request to determine whether SDT is allowed. In response to the request from the RRC layer 202, the MAC layer 206 may operate to determine whether one or more criteria about allowance of SDT initiation are satisfied.

If it is determined at the MAC layer 206 that the SDT is allowed or available to be initiated, for example, if the criteria set at the MAC layer 206 are determined to be satisfied, the RRC layer 202 may initiate 306A a communication procedure for SDT (also referred to as a SDT procedure) with the second device 120. In some example embodiments, if it is determined at the MAC layer 206 that SDT is allowed to be initiated, the MAC layer 206 may send 305A an indication of allowance or availability of SDT initiation to the RRC layer 202. In response to this indication, the RRC layer 202 may operate to initiate a communication procedure for SDT with the second device 120.

In some example embodiments, as the MAC layer 206 also confirms that SDT is allowed, the RRC layer 202 may determine 306A to perform SDT RRC resumption with the radio bearers for SDT in order to initiate the communication procedure for SDT. The radio bearers to be resumed for SDT may include a signaling radio bearer (SRB), such as SRB1 or SRB2, and a data radio bearer (DRB) for SDT. In an example embodiment, the RRC layer 202 may resume SRB1 or SRB2 for SDT. In an example embodiment, the RRC layer 202 may transmit 307, to the PDCP layer 204, a request to resume at least one radio bearer (e.g., SRB or DRB) for SDT. In some example embodiments, following the resumption of the radio bearer, the PDCP layer 204 may submit 309 the data to be transmitted to a lower layer, such as a RLC layer, for further handling by the MAC layer 206. In some example embodiments, to initiate the communication procedure for SDT, the RRC layer 202 may further send 308A, to the MAC layer 206, a common control channel (CCCH) RRC resume request for SDT. Through the above processing, the communication procedure for SDT may be initiated at the first device 110, and data may be transmitted to the second device 120 using the communication procedure for SDT.

In the conventional protocol stack, if the RRC layer of a device determines that communication for SDT with another device can be initiated, the RRC layer may directly resume a radio bearer such as a DRB and/or a SRB. If the SDT is found not available at the MAC layer, for example, the resources for SDT is invalid, the falsely resumed radio bearer may cause complicated problems in the protocol stacks. According to the example embodiments of the present disclosure, by checking the allowance of SDT initiation at both the RRC layer and MAC layer, it is possible to avoid the false resume of radio bearer if SDT is found to be unavailable at the MAC layer in which case unnecessary interactions may have been performed among the protocol layers.

Some detailed examples about the criteria for allowance of SDT initiation split among the RRC layer 202 and the MAC layer 206 will be discussed below. To better understand the criteria to be discussed, some example SDT modes are introduced first.

In some example embodiments, SDT may be performed based on a random access (RA) procedure or using a Configured Grant (CG). Accordingly, two or more different SDT modes may be defined based on the resource types (e.g., the RA resources or CG resources) used for the SDT procedure. In some example, a SDT mode based on a RA procedure may be referred to as a RA-based SDT mode or a RA-SDT mode. A SDT mode using a CG for data communication may be referred to as a CG-based SDT mode or a CG-SDT mode. In a RA-based SDT mode, the data may be transmitted from the first device 110 to the second device 120 in MsgA in a two-step RA procedure or in Msg3 in a four-step RA procedure. In a CG-based SDT mode, a data transmission(s) may be directly performed using resources of a CG, for example, resources of a configured grant type-1.

In some example embodiments, as a RA procedure may include a two-step RA procedure or a four-step RA procedure, there may be different RA-based SDT modes, one using a two-step RA procedure and one using a four-step RA procedure. The RA-based SDT mode based on the two-step RA resource may be referred to as a two-step RA-based SDT mode, and the RA-based SDT mode based on the four-step RA resource may be referred to as a four-step RA-based SDT mode. According to the two-step RA-based SDT mode, data may be transmitted from the first device 110 to the second device 120 in MsgA in a two-step RA procedure initiated with the second device 120. According to the four-step RA-based SDT mode, data may be transmitted in Msg3 in a four-step RA procedure initiated with the second device 120.

It would be appreciated that although some SDT modes are described in some example embodiments of the present disclosure, there may be other SDT modes applicable. In some example embodiments, a plurality of different SDT modes may be defined based on the specific numbers or number ranges of successive data transmissions allowed in a SDT procedure. For example, a SDT mode may be defined as allowing only one data transmissions during a SDT procedure, another SDT mode may be defined as allowing two or more data transmissions during a SDT procedure, and so on.

To determine 302 whether SDT is allowed or not at the RRC layer 202, radio bearer data availability-based criteria may be applied at the RRC layer 202 for SDT. In some example embodiments, the RRC layer 202 may determine whether there is one or more radio bearer allowed for SDT and whether data is available in at least one radio bearer allowed for SDT. In some cases, not all the radio bearers are configured for SDT. If the RRC layer 202 determines that there is no data available on the radio bearer(s) for SDT, the RRC layer 202 may determine that SDT is not allowed. Otherwise, the RRC layer 202 may determines that the radio bearer data availability-based criteria are satisfied.

In some example embodiments, as an alternative or additionally, the RRC layer 202 may further determine whether one or more threshold-based criteria for SDT are satisfied. The threshold-based criteria may include a criterion based on a data volume threshold configured for SDT. The RRC layer 202 may determine whether a volume of data to be transmitted meets a requirement based on a data volume threshold configured for SDT. In some example embodiments, the requirement may be common to SDT not specific to a SDT mode, and a data volume threshold for SDT may be set to the RRC layer 202. It may define that the requirement for SDT is fulfilled if the volume of data to be transmitted is below or equal to (or alternatively strictly below) the data volume threshold. In this case, by comparing the volume of data with the data volume threshold, the RRC layer 202 may determine whether SDT is allowed to be initiated or not.

In some example embodiments, the first device 110 may be configured with one or more SDT modes and one or more data volume thresholds specific to the one or more SDT modes may be set to the RRC layer 202. The requirement to initiate a SDT mode may be fulfilled if the data volume threshold specific to this SDT mode is satisfied. For example, a first data volume threshold is configured for a first SDT mode, and a second data volume threshold may be configured for a second SDT mode. The first data volume threshold may be lower than the second data volume threshold. If the first device 110 may determine that the volume of data to be transmitted is below or equal to the first data volume threshold for the first SDT mode, the first SDT mode may be selected for initiation. In some example embodiments, if the first device 110 may determine that the volume of data to be transmitted exceeds the first data volume threshold and is below or equal to the second data volume threshold for the second SDT mode, the first device 110 may select the second SDT mode.

In some example embodiments, in addition or as alternative to the data volume threshold-based criterion, the threshold-based criteria may include a criterion based on a channel quality threshold configured for SDT. A channel quality between the first device 110 and the second device 120 may be compared with the channel quality threshold to determine whether SDT is allowed or not. In some example embodiments, the channel quality may be measured based on one or more of reference signal received power (RSRP), reference signal received quality (RSRQ), and/or other factors reflecting a channel quality between the first device 110 and the second device 120, such as Signal to Interference Noise Ratio (SINR) or pathloss. The RRC layer 202 may determine whether the channel quality meets a requirement based on a channel quality threshold configured for SDT. In some example embodiments, the requirement may be common to SDT not specific to a SDT mode, and a channel quality threshold for SDT may be set to the RRC layer 202. It may define that the requirement for SDT is fulfilled if the channel quality exceeds the channel quality threshold. In this case, by comparing the channel quality with the channel quality threshold, the RRC layer 202 may determine whether SDT is allowed to be initiated or not. In some example embodiments, similarly to the data volume threshold-based criterion, one or more channel quality thresholds specific to one or more SDT modes may be set to the RRC layer 202. By comparing the channel quality with the SDT mode-specific thresholds, the RRC layer 202 may determine which SDT mode(s) may be allowed to be initiated.

In some example embodiments, as an alternative or additionally, the RRC layer 202 may further apply some resource availability-based criteria for SDT. The RRC layer 202 may determine whether there is a resource configured for SDT. For example, the RRC layer 202 may determine whether there is a CG configured for SDT, and/or there is a RA resource configured for SDT. The SDT is determined at the RRC layer 202 as being allowed to be initiated if the first device 110 is configured with a CG and/or a RA resource for SDT.

In some example embodiments, the RRC layer 202 may not determine the validity of the configured resource for SDT. The validation on the configured resource for SDT may be performed at the MAC layer 206. As indicated above, the communication procedure for SDT is initiated by the RRC layer 202 after the MAC layer 206 also confirms that SDT is allowed. As such, it is possible to prevent the RRC layer 202 from initiating the communication procedure when there are no valid resources.

In some example embodiments, as the RRC layer 202 may not be configured to determine which type of RA procedure is to be initiated for communication with the second device 120 or whether a RA procedure or a CG-based procedure is to be initiated, the criteria applied at the RRC layer 202 may not be specific to a SDT mode, but are general to all possible SDT modes.

In some example embodiments, the RRC layer 202 may be able to determine which one or more SDT modes may be allowed after applying its criteria. For example, the RRC layer 202 may be configured with one or more data volume-based criteria or channel quality-based criteria that are specific to one or more SDT modes, e.g., the CG-based SDT mode, RA-based SDT mode, two-step or four-step based SDT mode. In this case, if any of the criteria is satisfied, the RRC layer 202 may determine that the corresponding SDT mode(s) are allowed to be initiated.

In some example embodiments, the RRC layer 202 may perform the checking on the criteria which do not depend on the selection of the SDT modes nor the selection of UL carriers (for example, normal UL carrier or supplementary UL (SUL) carrier).

Various criteria at the RRC layer 202 are discussed above. It would be appreciated that the RRC layer 202 may apply one or more of the above criteria and/or other possible criteria to determine the allowance of SDT. The scope of the present disclosure is not limited in this regard.

As mentioned above, if the RRC layer 202 determines based on its criteria that SDT is allowed to be initiated, it may not directly initiate a communication procedure for SDT to communicate the data. Instead, the RRC layer 202 may send 303 a request to the MAC layer 206 to further determine whether and when SDT can be allowed before it initiates the communication procedure. In some example embodiments, if the RRC layer 202 is able to determine one or more target SDT modes are allowed to be initiated, it may send 303 a request to the MAC layer 206, to determine whether the one or more target SDT modes are allowed to be initiated at the second protocol layer.

At the MAC layer 206, if it receives the request for determining allowance of one or more specific target SDT modes, it may apply its criteria with respect to those SDT modes, to determine whether any of them is allowed based on its criteria. In other cases, the MAC layer 206 receives a general request from the RRC layer 202 to determine whether there is any SDT mode can be initiated. The MAC layer 206 may apply its criteria to check allowance of SDT or allowance of all the possible SDT modes configured for the first device 110.

To determine 304 whether SDT is allowed or not at the RRC layer 202, radio bearer data availability-based criteria may be applied for SDT. In some example embodiments, the RRC layer 202 may determine whether SDT is allowed to be initiated if there are not different modes specified for SDT. In some example embodiments, the MAC layer 206 may determine the allowance of initiation with respect to one or more SDT modes configured for the first device 110. As mentioned above, in some example embodiments, the SDT modes may be indicated by the RRC layer 202.

In some example embodiments, the first device 110 may be configured with a plurality of UL carriers (such as normal UL carriers or SUL carriers) for communication with the second device 120. In such case, the MAC layer 206 may select one of the UL carriers for communication. In some example embodiments, the selection of UL carriers may follow a legacy selection mechanism that is irrelevant with SDT. In an example embodiment, the selection of UL carriers may be performed based on a channel quality threshold which is not specifically configured for SDT or any SDT mode.

In some example embodiments, a channel quality threshold may be configured for SDT may be set for the MAC layer 206, which may be different from the threshold used in the legacy selection mechanism. To select a UL carrier, the MAC layer 206 may determine whether a channel quality over a given UL carrier meets a requirement based on the channel quality threshold configured for SDT. In some examples, the requirement may be met if the channel quality over the given UL carrier exceeds the specific channel quality threshold. In this case, the MAC layer 206 may select the given UL carrier.

With the UL carrier selected, the MAC layer 206 may apply further criteria (if any) to determine whether SDT is allowed to be initiated on the selected UL carrier. In some example embodiments, the MAC layer 206 may apply resource validity-based criteria for SDT. The MAC layer 206 may determine whether a resource is configured and valid for the SDT, or whether a resource is configured and valid for a specific SDT mode.

For example, if a CG is configured for the first device 110 to perform SDT, the MAC layer 206 may determine whether the CG is valid by determining whether the timing advance (TA) of the first device 110 is valid. The CG is determined to be valid if the TA is valid. In some example embodiments, a new TA timer for TA maintenance may be configured for the CG-based SDT. In some example embodiments, additionally or alternatively, the validity of the CG for SDT may be based on other factors, including whether one or more beams are valid for the CG, whether the CG is associated with the selected synchronization signal block (SSB), whether the channel quality (e.g., RSRP) has changed above a corresponding channel quality threshold, and the like. The scope of the present disclosure is not limited in this regard.

In some example embodiments, if a RA resource is configured for the first device 110, the MAC layer 206 may further determine whether the RA resource is valid for SDT. In some example embodiments, the MAC layer 206 may determine a two-step RA resource or a four-step RA resource is available and valid for SDT. The RA resource may include, for example, physical random access channel (PRACH) and preambles and probably, dedicated radio resources for a RA procedure for SDT.

In some example embodiments, by checking the validity of CG and/or RA resource, the MAC layer 206 may be able to determine whether a CG-based SDT mode or a RA-based SDT mode (e.g., a two-step RA-based SDT mode or a four-step RA-based SDT mode) is allowed to be initiated.

In some example embodiments, as an alternative or additionally, the MAC layer 206 may further determine whether one or more threshold-based criteria for SDT are satisfied. The threshold-based criteria may include a criterion based on a data volume threshold configured for SDT, a criterion based on a channel quality threshold configured for SDT. In some example embodiments, the RRC layer 202 may not need to perform the threshold-based criteria checking for SDT if the MAC layer 206 is configured with the threshold-based criteria. In some example embodiments, both the RRC layer 202 and the MAC layer 206 may perform the threshold-based criteria checking for SDT, but different thresholds may be set at the two layers.

In some example embodiments, similar to the criterion described above with respect to the RRC layer 202, the criterion based on a data volume threshold may include a requirement based on a data volume threshold configured for SDT or may include a requirement based on one or more data volume thresholds configured specifically for one or more SDT modes. In some example embodiments, the criterion based on a channel quality threshold may include a requirement based on a channel quality threshold configured for SDT or may include a requirement based on one or more channel quality thresholds configured specifically for one or more SDT modes. By comprising the volume of data to be transmitted with the corresponding data volume threshold(s), and/or by the channel quality with the corresponding channel quality threshold(s), the MAC layer 206 may determine whether SDT is allowed or which SDT mode is allowed. In some example embodiments, the SDT is allowed when both the criteria based on the data volume threshold and channel quality threshold are satisfied.

Various criteria at the MAC layer 206 are discussed above. It would be appreciated that the MAC layer 206 may apply one or more of the above criteria and/or other possible criteria to determine the allowance of SDT. The scope of the present disclosure is not limited in this regard. As mentioned above, if it is determined at the MAC layer 206 that SDT is allowed to be initiated, the MAC layer 206 may send 305A an indication of allowance or availability of SDT initiation to the RRC layer 202. In some example embodiments, if the MAC layer 206 determines that a specific SDT mode is allowed, the MAC layer 206 may send 305A an indication of the allowed SDT mode to the RRC layer 202. In response to the indication from the MAC layer 206, the RRC layer 202 may operate to initiate a communication procedure for SDT with the second device 120. If the specific SDT mode is indicated, the RRC layer 202 may initiate the communication procedure according to the SDT mode.

In the above mentioned embodiments, the operations of the protocol layers when SDT is determined to be allowed are described. In some cases, if SDT is found to be disallowed at the RRC layer 202 or the MAC layer 206, for example, if one or more of the criteria at the RRC layer 202 or the MAC layer 206 are failed to be satisfied, the first device 110 may initiate a communication procedure for non-SDT with the second device 120. Reference is still made to FIG. 2. If the RRC layer 202 determines that SDT is disallowed, for example, because there is no resource or radio bearer configured or allowed for SDT, the RRC layer 202 may initiate 306B a communication procedure for non-SDT (also referred to as a non-SDT procedure) with the second device 120. For example, the RRC layer 202 may determine to resume a SBR, e.g., SRB1, for the communication procedure for non-SDT. The RRC layer 202 may further send 308B, to the MAC layer 206, a CCCH RRC resume request for non-SDT. The PDCP layer 204 and MAC layer 206 may operate accordingly to perform the communication procedure for non-SDT. Data may be transmitted to the second device 120 using a non-SDT procedure.

If the RRC layer 202 determines that SDT is allowed but the MAC layer 206 determines that SDT is not allowed to be initiated, the MAC layer 206 may send 305B an indication of disallowance or unavailability of SDT initiation to the RRC layer 202. Upon reception of such an indication from the MAC layer 206, the RRC layer 202 may initiate 306B a communication procedure for non-SDT accordingly.

The interactions between the protocol layers are discussed above. An example procedure to be performed at the MAC layer 206 according to some example embodiments may be summarized as below. The corresponding steps in the signaling flow 300 are marked below.
Upon a request of initiating a SDT procedure (step 303), MAC perform the SUL/UL selection based on SUL/UL_SDT_RSRP threshold (which could be the same or different as legacy SUL/UL RSRP threshold) (step 304);
After UL carrier selection (step 304),
   MAC does CG validation on the selected UL carrier (including TA, beam, RSRP criteria, etc.) (step 304);
      if there is valid CG for SDT:
         MAC indicates to RRC that (CG-)SDT can be initiated and performs CG-SDT (step 305A);
      if no valid CG (not configured or any criteria is not fulfilled):
         MAC checks RA-SDT availability for 2-step and 4-step and performs 2-step/4-step RA selection based on 2-step/4-step RA SDT-RSRP threshold (which could be same or different as legacy 2-step/4-step selection RSRP threshold) (step 304),
         If there is valid RA resource for SDT for the selected RA type,
         MAC indicates to RRC that (RA-)SDT can be initiated and performs RA-SDT accordingly (step 305A);
   If there is no valid CG for SDT nor valid 2-step or 4-step RA resource for SDT on the selected UL (note that this allows the possibility of the first device 110 only configured with CG-SDT resources without RA-SDT, or only with 2-step or 4-step RA configured for SDT) (step 304);
      MAC indicates to RRC that a SDT procedure cannot be performed (step 305B).

An example procedure to be performed at the RRC layer 202 according to some example embodiments may be summarized as below. The corresponding steps in the signaling flow 300 are marked below.
if SDT criteria, e.g. whether SDT is configured for the relevant DRB and whether UL payload fits the SDT threshold and whether SDT-RSRP criteria are fulfilled (step 302),
   Request MAC to perform SDT resource validation (step 303);
If SDT available indication is received from MAC (step 305A),
   Resume SRB1/(SRB2)/SDT DRB(s) (steps 307 and 308A),
   Perform SDT resume and send resume for SDT to MAC (steps 306A and 309);
If SDT unavailable indication is received from MAC (step 305B),
   Resume SRB1,
   Perform non-SDT resume (steps 306B and 308B).

FIG. 4 shows a flowchart of an example method 400 implemented at a first device 110 in accordance with some example embodiments of the present disclosure. For the purpose of discussion, the method 400 will be described from the perspective of the first device 110 with respect to FIG. 1.

At block 410, the first device 110 determines whether a SDT is allowed to be initiated at a first protocol layer (e.g., the RRC layer 202) of the first device 110. If the SDT is allowed to be initiated at the first protocol layer, at block 420, the first device 110 determines whether the SDT is allowed to be initiated at a second protocol layer (e.g., the MAC layer 206) of the first device 110. If the SDT is allowed to be initiated at the second protocol layer, at block 430, the first device 110 initiates, via the first protocol layer, a communication procedure for the SDT with a second device 120.

In some example embodiments, if the SDT is disallowed to be initiated at the first protocol layer or at the second protocol layer, at block 440, the first device 110 may initiate, via the first protocol layer, a further communication procedure for non-SDT with the second device 120.

In some example embodiments, the first device 110 may determine that the SDT is allowed to be initiated at the first protocol layer by determining that at least one of the following criteria is satisfied: a resource for the SDT is configured, a resource for at least one SDT mode is configured, data is available in at least one radio bearer allowed for the SDT, or a volume of data to be transmitted meets a requirement based on a first data volume threshold configured for the SDT.

In some example embodiments, at least one SDT mode comprises at least one of the following: a first SDT mode based on a configured grant, a second SDT mode based on a random access procedure, a third SDT mode based on a two-step random access procedure, and a fourth SDT mode based on a four-step random access procedure.

In some example embodiments, if the SDT is allowed to be initiated at the first protocol layer, the first device 110 may cause one of the following requests to be transmitted from the first protocol layer to the second protocol layer: a first request to determine whether the SDT is allowed to be initiated at the second protocol layer, or a second request to determine whether a target SDT mode is allowed to be initiated at the second protocol layer.

In some example embodiments, the first device 110 may determine whether the SDT is allowed to be initiated at the second protocol layer by: in response to the first request, determining whether the SDT is allowed to be initiated at the second protocol layer, or in response to the second request, determining whether the target SDT mode is allowed to be initiated at the second protocol layer.

In some example embodiments, the first device 110 may determine whether the SDT is allowed to be initiated at the second protocol layer by: determining whether at least one SDT mode is allowed to be initiated at the second protocol layer.

In some example embodiments, if one of the at least one SDT mode is allowed to be initiated at the second protocol layer, the first device 110 may cause an indication of the determined SDT mode to be transmitted from the second protocol layer to the first protocol layer. The first device 110 may initiate the communication procedure for the SDT by: in response to the indication of the determined SDT mode, initiating, via the first protocol layer, the communication procedure according to the determined SDT mode.

In some example embodiments, the first device 110 may determine that the SDT is allowed to be initiated at the second protocol layer by determining at least one of the following criteria is satisfied: a resource configured for the SDT is valid, a resource configured for at least one SDT mode is valid, a volume of data to be transmitted meets a requirement based on a second data volume threshold configured for the SDT, the volume of data to be transmitted meets a requirement based on a third data volume threshold configured for at least one SDT mode, a channel quality between the first device 110 and the second device 120 meets a requirement based on a first quality threshold configured for the SDT, or the channel quality meets a requirement based on a second quality threshold configured for at least one SDT mode.

In some example embodiments, the first device 110 may determine whether the SDT is allowed to be initiated at the second protocol layer by: selecting one of a plurality of uplink carriers; and determining whether the SDT is allowed to be initiated on the selected uplink carrier.

In some example embodiments, the first device 110 may select one of a plurality of uplink carriers by: for a given uplink carrier of the plurality of uplink carriers, determining whether a channel quality over the given uplink carrier meets a requirement based on a fourth quality threshold configured for the SDT or a requirement based on a fifth quality threshold configured for a SDT mode; and selecting the given uplink carrier in accordance with a determination that the channel quality meets the requirement based on the fourth quality threshold or the requirement based on the fifth quality threshold.

In some example embodiments, the first device 110 may initiate, via the first protocol layer, the communication procedure for the SDT by: causing a third request to be transmitted from the first protocol layer to a third protocol layer (e.g., the PDCP layer 204) of the first device 110 to resume at least one radio bearer for the SDT. In some example embodiments, the third protocol layer comprises a packet data convergence protocol layer.

In some example embodiments, a first apparatus capable of performing any of the method 300 (for example, the first device 110) may comprise means for performing the respective operations of the method 300. The means may be implemented in any suitable form. For example, the means may be implemented in a circuitry and/or software module. The first apparatus may be implemented as or included in the first device 110.

In some example embodiments, the first apparatus comprises: means for determining whether a small data transmission is allowed to be initiated at a first protocol layer of the first apparatus; means for, in accordance with a determination that the small data transmission is allowed to be initiated at the first protocol layer, determining whether the small data transmission is allowed to be initiated at a second protocol layer of the first apparatus; and means for, in accordance with a determination that the small data transmission is allowed to be initiated at the second protocol layer, initiating, via the first protocol layer, a communication procedure for the small data transmission with a second apparatus (for example, the second device 120).

In some example embodiments, the means for determining whether the small data transmission is allowed to be initiated at the first protocol layer comprises means for determining that the small data transmission is allowed to be initiated at the first protocol layer by determining that at least one of the following criteria is satisfied: a resource for the small data transmission is configured, a resource for at least one small data transmission mode is configured, data is available in at least one radio bearer allowed for the small data transmission, or a volume of data to be transmitted meets a requirement based on a first data volume threshold configured for the small data transmission.

In some example embodiments, at least one small data transmission mode comprises at least one of the following: a first small data transmission mode based on a configured grant, a second small data transmission mode based on a random access procedure, a third small data transmission mode based on a two-step random access procedure, and a fourth small data transmission mode based on a four-step random access procedure.

In some example embodiments, the first apparatus further comprises: means for, in accordance with a determination that the small data transmission is allowed to be initiated at the first protocol layer, cause one of the following requests to be transmitted from the first protocol layer to the second protocol layer: a first request to determine whether the small data transmission is allowed to be initiated at the second protocol layer, or a second request to determine whether a target small data transmission mode is allowed to be initiated at the second protocol layer.

In some example embodiments, the means for determining whether the small data transmission is allowed to be initiated at the second protocol layer comprises means for, in response to the first request, determining whether the small data transmission is allowed to be initiated at the second protocol layer, or means for, in response to the second request, determining whether the target small data transmission mode is allowed to be initiated at the second protocol layer.

In some example embodiments, the means for determining whether the small data transmission is allowed to be initiated at the second protocol layer comprises means for determining whether at least one small data transmission mode is allowed to be initiated at the second protocol layer.

In some example embodiments, the first apparatus further comprises: means for, in accordance with a determination that one of the at least one small data transmission mode is allowed to be initiated at the second protocol layer, cause an indication of the determined small data transmission mode to be transmitted from the second protocol layer to the first protocol layer. In some example embodiments, the means for initiating the communication procedure for the small data transmission comprises means for, in response to the indication of the determined small data transmission mode, initiating, via the first protocol layer, the communication procedure according to the determined small data transmission mode.

In some example embodiments, the means for determining whether the small data transmission is allowed to be initiated at the second protocol layer comprises: means for determining that the small data transmission is allowed to be initiated at the second protocol layer by determining at least one of the following criteria is satisfied: a resource configured for the small data transmission is valid, a resource configured for at least one small data transmission mode is valid, a volume of data to be transmitted meets a requirement based on a second data volume threshold configured for the small data transmission, the volume of data to be transmitted meets a requirement based on a third data volume threshold configured for at least one small data transmission mode, a channel quality between the first apparatus and the second apparatus meets a requirement based on a first quality threshold configured for the small data transmission, or the channel quality meets a requirement based on a second quality threshold configured for at least one small data transmission mode.

In some example embodiments, the means for determining whether the small data transmission is allowed to be initiated at the second protocol layer comprises: mean for selecting one of a plurality of uplink carriers; and mean for determining whether the small data transmission is allowed to be initiated on the selected uplink carrier.

In some example embodiments, the means for selecting one of a plurality of uplink carriers comprises: for a given uplink carrier of the plurality of uplink carriers, means for determining whether a channel quality over the given uplink carrier meets a requirement based on a fourth quality threshold configured for the small data transmission or a requirement based on a fifth quality threshold configured for a small data transmission mode; and means for selecting the given uplink carrier in accordance with a determination that the channel quality meets the requirement based on the fourth quality threshold or the requirement based on the fifth quality threshold.

In some example embodiments, the means for initiating, via the first protocol layer, the communication procedure for the small data transmission comprise: means for causing a third request to be transmitted from the first protocol layer to a third protocol layer of the first apparatus to resume at least one radio bearer for the small data transmission.

In some example embodiments, the third protocol layer comprises a packet data convergence protocol layer. In some example embodiments, the first protocol layer comprises a radio resource control layer, and wherein the second protocol comprises a medium access control layer.

In some example embodiments, the first apparatus further comprises: means for, in accordance with a determination that the small data transmission is disallowed to be initiated at the first protocol layer or at the second protocol layer, initiate, via the first protocol layer, a further communication procedure for non-small data transmission with the second apparatus.

In some example embodiments, the first apparatus further comprises means for performing other operations in some example embodiments of the method 400 or the first device 110. In some example embodiments, the means comprises at least one processor; and at least one memory including computer program code, the at least one memory and computer program code configured to, with the at least one processor, cause the performance of the first apparatus.

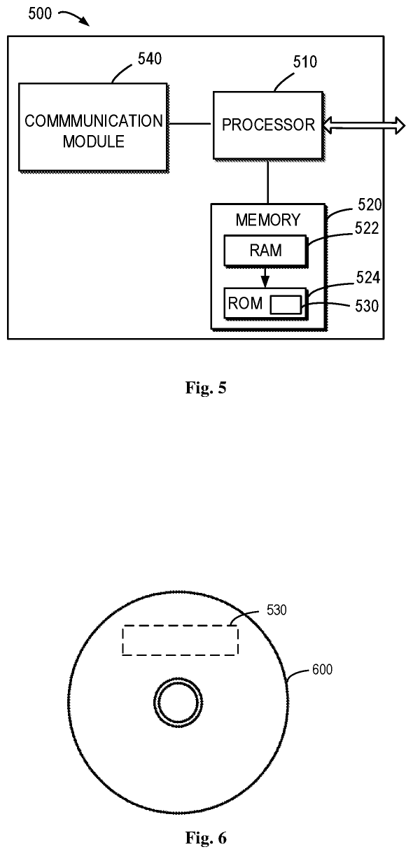

FIG. 5 is a simplified block diagram of a device 500 that is suitable for implementing example embodiments of the present disclosure. The device 500 may be provided to implement a communication device, for example, the first device 110 or the second device 120 as shown in FIG. 1. As shown, the device 500 includes one or more processors 510, one or more memories 520 coupled to the processor 510, and one or more communication modules 540 coupled to the processor 510.

The communication module 540 is for bidirectional communications. The communication module 540 has one or more communication interfaces to facilitate communication with one or more other modules or devices. The communication interfaces may represent any interface that is necessary for communication with other network elements. In some example embodiments, the communication module 540 may include at least one antenna.

The processor 510 may be of any type suitable to the local technical network and may include one or more of the following: general purpose computers, special purpose computers, microprocessors, digital signal processors (DSPs) and processors based on multicore processor architecture, as non-limiting examples. The device 500 may have multiple processors, such as an application specific integrated circuit chip that is slaved in time to a clock which synchronizes the main processor.

The memory 520 may include one or more non-volatile memories and one or more volatile memories. Examples of the non-volatile memories include, but are not limited to, a Read Only Memory (ROM) 524, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 522 and other volatile memories that will not last in the power-down duration.

A computer program 530 includes computer executable instructions that are executed by the associated processor 510. The program 530 may be stored in the memory, e.g., ROM 524. The processor 510 may perform any suitable actions and processing by loading the program 530 into the RAM 522.

The example embodiments of the present disclosure may be implemented by means of the program 530 so that the device 500 may perform any process of the disclosure as discussed with reference to FIGS. 3 to 4. The example embodiments of the present disclosure may also be implemented by hardware or by a combination of software and hardware.

In some example embodiments, the program 530 may be tangibly contained in a computer readable medium which may be included in the device 500 (such as in the memory 520) or other storage devices that are accessible by the device 500. The device 500 may load the program 530 from the computer readable medium to the RAM 522 for execution. The computer readable medium may include any types of tangible non-volatile storage, such as ROM, EPROM, a flash memory, a hard disk, CD, DVD, and the like. FIG. 6 shows an example of the computer readable medium 600 which may be in form of CD, DVD or other optical storage disk. The computer readable medium has the program 530 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target physical or virtual processor, to carry out any of the methods as described above with reference to FIGS. 3 to 4. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A first device comprising:
at least one processor; and
at least one memory including computer program code;
wherein the at least one memory and the computer program code are configured to, with the at least one processor, cause the first device to:
determine whether a small data transmission is allowed to be initiated at a first protocol layer of the first device;
in accordance with a determination that the small data transmission is allowed to be initiated at the first protocol layer, determine whether the small data transmission is allowed to be initiated at a second protocol layer of the first device; and
in accordance with a determination that the small data transmission is allowed to be initiated at the second protocol layer, initiate, via the first protocol layer, a communication procedure for the small data transmission with a second device.

2. The first device of claim 1, wherein the at least one memory and the computer program code are configured to, with the at least one processor, cause the first device to determine that the small data transmission is allowed to be initiated at the first protocol layer by determining that at least one of the following criteria is satisfied:
a resource for the small data transmission is configured,
a resource for at least one small data transmission mode is configured,
data is available in at least one radio bearer allowed for the small data transmission, or
a volume of data to be transmitted meets a requirement based on a first data volume threshold configured for the small data transmission.

3. The first device of claim 2, wherein at least one small data transmission mode comprises at least one of the following:
a first small data transmission mode based on a configured grant,
a second small data transmission mode based on a random access procedure,
a third small data transmission mode based on a two-step random access procedure, and
a fourth small data transmission mode based on a four-step random access procedure.

4. The first device of claim 1, wherein the at least one memory and the computer program code are configured to, with the at least one processor, further cause the first device to:
in accordance with a determination that the small data transmission is allowed to be initiated at the first protocol layer, cause one of the following requests to be transmitted from the first protocol layer to the second protocol layer:
a first request to determine whether the small data transmission is allowed to be initiated at the second protocol layer, or
a second request to determine whether a target small data transmission mode is allowed to be initiated at the second protocol layer.

5. The first device of claim 4, wherein the at least one memory and the computer program code are configured to, with the at least one processor, cause the first device to:
in response to the first request, determine whether the small data transmission is allowed to be initiated at the second protocol layer, or
in response to the second request, determine whether the target small data transmission mode is allowed to be initiated at the second protocol layer.

6. The first device of claim 1, wherein the at least one memory and the computer program code are configured to, with the at least one processor, cause the first device to determine whether at least one small data transmission mode is allowed to be initiated at the second protocol layer.

7. The first device of claim 6, wherein the at least one memory and the computer program code are configured to, with the at least one processor, further cause the first device to:
in accordance with a determination that one of the at least one small data transmission mode is allowed to be initiated at the second protocol layer, cause an indication of the determined small data transmission mode to be transmitted from the second protocol layer to the first protocol layer; and
wherein the at least one memory and the computer program code are configured to, with the at least one processor, cause the first device to initiate the communication procedure for the small data transmission by:
in response to the indication of the determined small data transmission mode, initiating, via the first protocol layer, the communication procedure according to the determined small data transmission mode.

8. The first device of claim 1, wherein the at least one memory and the computer program code are configured to, with the at least one processor, cause the first device to determine that the small data transmission is allowed to be initiated at the second protocol layer by determining at least one of the following criteria is satisfied:
a resource configured for the small data transmission is valid,
a resource configured for at least one small data transmission mode is valid,
a volume of data to be transmitted meets a requirement based on a second data volume threshold configured for the small data transmission,
the volume of data to be transmitted meets a requirement based on a third data volume threshold configured for at least one small data transmission mode,
a channel quality between the first device and the second device meets a requirement based on a first quality threshold configured for the small data transmission, or
the channel quality meets a requirement based on a second quality threshold configured for at least one small data transmission mode.

9. The first device of claim 1, wherein the at least one memory and the computer program code are configured to, with the at least one processor, cause the first device to:
select one of a plurality of uplink carriers; and
determine whether the small data transmission is allowed to be initiated on the selected uplink carrier.

10. The first device of claim 9, wherein the at least one memory and the computer program code are configured to, with the at least one processor, cause the first device to: for a given uplink carrier of the plurality of uplink carriers,
determine whether a channel quality over the given uplink carrier meets a requirement based on a fourth quality threshold configured for the small data transmission or a requirement based on a fifth quality threshold configured for a small data transmission mode; and
select the given uplink carrier in accordance with a determination that the channel quality meets the requirement based on the fourth quality threshold or the requirement based on the fifth quality threshold.

11. The first device of claim 1, wherein the at least one memory and the computer program code are configured to, with the at least one processor, cause the first device to cause a third request to be transmitted from the first protocol layer to a third protocol layer of the first device to resume at least one radio bearer for the small data transmission.

12. The first device of claim 11, wherein the third protocol layer comprises a packet data convergence protocol layer.

13. The first device of claim 1, wherein the first protocol layer comprises a radio resource control layer, and wherein the second protocol comprises a medium access control layer.

14. The first device of claim 1, wherein the at least one memory and the computer program code are configured to, with the at least one processor, further cause the first device to:
in accordance with a determination that the small data transmission is disallowed to be initiated at the first protocol layer or at the second protocol layer, initiate, via the first protocol layer, a further communication procedure for non-small data transmission with the second device.

15. The first device of claim 1, wherein the first device comprises a terminal device, and the second device comprises a network device.

16. A method comprising:
determining, at a first device, whether a small data transmission is allowed to be initiated at a first protocol layer of the first device;
in accordance with a determination that the small data transmission is allowed to be initiated at the first protocol layer, determining whether the small data transmission is allowed to be initiated at a second protocol layer of the first device; and
in accordance with a determination that the small data transmission is allowed to be initiated at the second protocol layer, initiating, via the first protocol layer, a communication procedure for the small data transmission with a second device.

17. A first apparatus comprising:
means for determining whether a small data transmission is allowed to be initiated at a first protocol layer of the first apparatus;
means for, in accordance with a determination that the small data transmission is allowed to be initiated at the first protocol layer, determining whether the small data transmission is allowed to be initiated at a second protocol layer of the first apparatus; and
means for, in accordance with a determination that the small data transmission is allowed to be initiated at the second protocol layer, initiating, via the first protocol layer, a communication procedure for the small data transmission with a second apparatus.

18. A computer readable medium comprising program instructions for causing an apparatus to perform at least the method of claim 16.
